(19) United States
(12) Patent Application Publication
(10) Pub. No.: US 2011/0270751 A1
(43) Pub. Date: Nov. 3, 2011

(54) Electronic commerce system and system and method for establishing a trusted session

(76) Inventors: Andrew Csinger, Vancouver (CA); John Bradley, Talagante (CL); Sven Olsen, Victoria (CA); Rich Cannings, Santa Cruz, CA (US)

(21) Appl. No.: 12/961,509

(22) Filed: Dec. 7, 2010

Related U.S. Application Data
(60) Provisional application No. 61/300,023, filed on Jan. 31, 2010.
(60) Provisional application No. 61/300,020, filed on Jan. 31, 2010.
(60) Provisional application No. 61/286,019, filed on Dec. 14, 2009.

(51) Int. Cl. G06Q 40/00; G06F 21/00; G06F 15/16; H04L 9/32

(52) U.S. Cl. 705/42; 726/6

(57) ABSTRACT

A system and method for establishing two-factor security using a mobile device comprising authorizing one or more transactions requests received by a server, identifying one or more credentials required before the transaction can be processed, transmitting the list of credentials and a request session ID to a mobile device that stores, or is linked to, one or more required credentials, and pushing (or authorizing a credentials server to push) such credentials to the server that received the request in order to permit the associated transaction and/or upgrade the prior session to a secured or “authorized” connection.

### CROSS-REFERENCE TO RELATED APPLICATIONS

This application claims priority from U.S. Provisional Patent Application Nos. 61/300,023, 61/300,020, and 61/286,019. The entirety of those applications are incorporated herein by reference.

### TECHNICAL FIELD

This invention relates to the use of multiple devices to engender highly usable trusted transactional systems.

### BACKGROUND

Increasingly, customers are turning to the convenience of websites for accessing and managing financial account information and to engage in e-commerce and other online transactions. Consequently, Internet users face a growing threat from online fraud. Identity thieves take advantage of the anonymity of the Internet, and its ability to provide programmatic access to any information. Nevertheless, consumers remain enamored with the ease of use of Internet banking and e-commerce sites (Morgan Stanley estimates 61% of US population is online—181 million users) but do not do enough to protect themselves. For example, according to information obtained by RSA Security and Network Intelligence, 81% of people surveyed thought identity theft was a critical issue, but less than 46% were motivated to change passwords regularly and only 4% made the effort to check credit reports. As noted by the Federal Financial Institutions Examination Council (“FFIEC”), “an effective authentication system is necessary for compliance with requirements to safeguard customer information, to prevent money laundering and terrorist financing, to reduce fraud, to inhibit identity theft, and to promote the legal enforceability of . . . electronic agreements and transactions.” Consequently, online service providers, such as financial institutions (“FI”) and e-commerce merchants, have a need for secure and reliable online authentication solutions utilizing multiple factors (“multifactor”) of authentication.

Current methods of allowing customer access to financial information and electronic funds transfer capabilities online provide unsatisfactory levels of security. For example, a typical implementation of online authentication might involve a user, such as an account holder at an FI, selecting or being assigned a username and pass code (single-factor authentication) for access to secure information, such as account records. However, usernames and pass codes may be easily compromised through well-known Internet fraud techniques. According to the FFIEC's recently issued guidelines, stronger, multi-factor forms of authentication are needed. FFIEC agencies “consider single-factor authentication, as the only control mechanism, to be inadequate for high risk transactions involving access to customer information or the movement of funds to other parties. Financial institutions offering Internet-based products and services to their customers should use effective methods to authenticate the identity of customers using those products and services” (see Federal Financial Institutions Example Council, “Authentication in an Internet Banking Environment”, 2005).

Similar issues affect the operation and security of e-commerce websites. Most merchant websites currently implement their own identity management systems. While these systems provide a merchant the capability to manage its customer base and provide some level of personalization, the focus of online merchants is rapidly shifting to providing a security barrier against fraudulent access. With merchant websites requiring constant content and structure updates (what is developed today will soon be obsolete), no website is ever “complete” and is continually open to new security exploitations. As a result, the more often a customer registers and therefore stores their financial data on a merchant's website, the more likely the financial data will be compromised.

Some of the recent attempts to solve some of these problems involve things like tokens and/or one key to one lock. These often require yet another device for the user to carry AND it often only unlocks a single system. Furthermore, it requires a new link between the token or key and the user. (This situation is sometimes referred to as the “token-necklace problem.”) Alternative regimes enforced policies designed to engender trust among and between participants via systems such as PKI. These approaches are particularly cumbersome in healthcare where physicians are unlikely to carry (or want to carry) yet another authenticating device. And yet healthcare applications, such as e-prescribing, create a need for authentication that is arguably even more critical than financial transactions. One solution has been to send a PIN (or other rotating code) via SMS to a cell phone linked to the user. The risk with these is that services like SMS are often subject to error and could be sent to the wrong user, the wrong phone or could be intercepted en route.

What is needed, then, is a system and method for authenticating a connection by leveraging a device or tool already possessed by user (such as a mobile phone) that can improve upon the single-factor method without compromising convenience or security. The preferred solution would also make securing or sharing “state” information simple across multiple third party services or sites without the need for multiple keys or personal information stored at each and every merchant site.

### SUMMARY

The present invention addresses these needs and solves these problems by enabling “Trusted Session Migration.” In one embodiment of the invention, following receipt of a requested transaction from a user, a component on a “request server” would receive a request and assess what credentials are needed to perform the request. This process could be performed by either mapping the request to a list of required credentials or by reaching out to an appropriate security policy server that retrieves the list of required credentials to gain access to that information or request. The credentials required could require an authenticated identification, required external authorization or a combination of each. For example, in the case of a hospital, access to certain medical records may require (1) verification that the requester is the person identified in the medical records (name/DOB/etc) AND (2) physician authorization or authorization by specific medical personnel to approve the release. In this way, the requested transaction (in this case an access request) could be submitted by a user OTHER than the physician (such as a patient requesting access to their medical records) but only if the authorization requested was approved by the physician (or someone similarly authorized).

Once the required credentials are identified, the list of requested credentials is transmitted to one or more mobile devices. The information could be transmitted to the mobile devices in any number of ways including a SMS or push message to each mobile device, via a visual code such as a bar code/QR code, Bluetooth, nearfield (NFC) or other communication means.

For example, in one sample embodiment that is set forth in much greater detail below, a user requesting a medical record would be presented with a bar code by the terminal used to make that request that includes the requested authorization and information identifying the request “session”. With the assistance of an identity selector application running on the mobile device, the bar code is converted into a request on the mobile device to approve the sharing of one or more credentials that have been linked to that phone/person. In this example, the user would take a device, such as an iPhone™ and would use the identity application to read the code that the computer generated’, and use that bar code to present the user with a screen setting forth each requested credential and preferably giving them an “I agree” or “Transmit” or “Buy” button on the bottom as appropriate confirmation that they approve sharing the requested credentials or otherwise enabling a secondary transaction. Further functionality, such as enabling a user to elect one or more credentials “check box” style could also be provided.

In the case of medical records the required credentials could be name, social security and date of birth. While there are many ways to transmit the appropriate “verified credentials” back to the request server, in the simplest form, the mobile device would transmit one or more requested credentials directly back to the request server/application that received the initial request which could include one or more codes or passwords that verify that it is coming from a mobile device that has been linked to those credentials such as a unique mobile device identifier. Another alternative is that the mobile device would approve the sharing of credentials that are stored on a second “credentials server”. The credentials server could simply be a repository for credentials and could further include processing capabilities that permit it to perform one or more “pre qualifying” transactions. For example, in the case of identity, the request could include the identity that the server desires to authenticate and the credentialing server, responsive to approval from the mobile device, could match the records that is on file for the identity being authenticated and could verify that the credentials linked to the mobile device match the credentials received by the request server.

Once the verification and the transactions credentials have been met, the request server would “upgrade” the original session containing the request to a “trusted” session (or could otherwise create a trusted session using a previously generated session ID that is linked to that session type) and would permit the appropriate requested transaction over a secure line. The upgrade of the prior session could include upgrading the security of the session or even applying one or more additional features to the prior session that enable a broader array of transactions to occur.

### BRIEF DESCRIPTION OF THE DRAWINGS

FIG. 1: Sample QR Code—the scanning of this code with an iPhone-based camera and associated iPhone-based software results in the ability of the user to purchase a cup of coffee; many other uses are possible.

FIG. 2: Sample Landing Page screen-shot from an iPhone after scanning the above code.

FIG. 3: Trusted Session Transfer Flow Diagram

FIG. 4: Mobio's RP as OpenID provider (OP)

FIG. 5: Exemplary architecture—depicts an exemplary enhanced authentication service provider infrastructure architecture for online authentication

FIG. 6: Exemplary enhanced architecture—depicts an exemplary enhanced authentication service provider infrastructure architecture for online authentication

FIG. 7: Flow chart using an authentication method of the present invention

FIG. 8: Flow chart for an exemplary process of authenticating an enrolled user—depicts a flow chart for an exemplary process of authenticating an enrolled user in the context of retrieving one or more medical records.

FIG. 9: Diagram illustrating the entry point for the identity selector program

FIG. 10: Block diagram of the identity selector application illustrating the functional aspects of the identity selector application.

FIG. 11: Sample payment approval diagram using the identity selector application

FIG. 12: Barcode for Offer Propagation

FIG. 13: Landing Page for Offer Propagation

FIG. 14: Offer Propagation architecture

FIG. 15: Offer Propagation Hierarchy

FIG. 16: Offer Propagation Process Flow

FIG. 17: Original and Cylindrically Distorted Barcodes

### DETAILED DESCRIPTION

### Trusted Session Transfer

This invention of the assignee Mobio makes use of “trusted” devices to create “trusted” sessions on untrusted devices, by conveniently “moving” such “trusted” sessions between devices. The invention reduces the risk that sensitive information is improperly accessed on (or from) the untrusted device and offers an attractive trade-off between security and usability. Various use cases are described herein: 1) On-line (the Internet Café scenario); 2) Off-line (the 8½×11 POS); and 3) Everything Else.

Case 1: The Customer is browsing the web and while the session can be “secured” (e.g., via SSL/TLS encryption) the original, requesting terminal may not be “trusted,” as in the case of an internet café of unknown (and possibly bad) repute. The secure session is “transferred” to a device, which is “trusted” to/by the requestor, e.g., a personal communications device such as a mobile phone. This trusted device performs the sensitive identification elements of the transaction (which can include payment functions), after which the session can be transferred back to the untrusted device, if desired. (As implied herein, the original session can in this way be “upgraded” from merely secure to “secure and trusted.”)

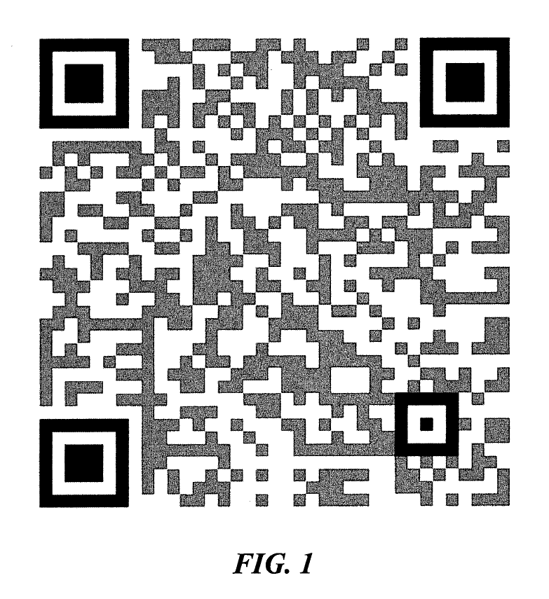

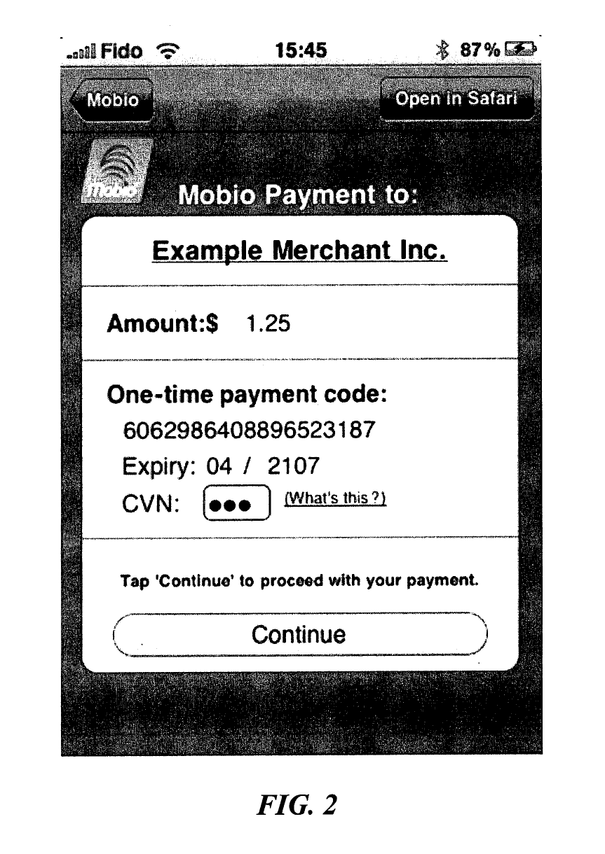

Case 2: Static codes in e.g., off-line devices. In particular, a session can be transferred from a barcode printed on a piece of paper to a trusted device, where a transaction can be completed. In particular, a piece of paper can function as a point-of-sale (POS) device at a retail outlet, where the barcode can be scanned by a user's mobile phone. For instance, the scanning of this code with an iPhone-based camera and the associated iPhone-based software results in the ability of the user to purchase a cup of coffee. Many other uses are possible. See FIGS. 1 and 2.

Assertion Browser based authentication protocols like SAML (Web SSO), OpenID, oAuth and WS-Fed (Passive) provide an assertion/token (Secondary Authenticator) from an IdP/OP to the RP/SP (Relying Party or Service Provider) via a front channel communication (i.e., via the user agent). This front-channel communication method involving user browser agents is typically implemented as an HTTP redirect, where the flow in these protocols typically involves the RP/SP redirecting the User's browser session to the IdP/OP via a 30x http redirect. The IdP/OP uses browser cookies to create a secure but unauthenticated session between itself and the user agent. The IdP/OP then typically creates a trusted session with the user agent (browser) by exchanging one or more primary authenticators such as UserName/Password or (Public Key Infrastructure) PKI-based authentication with the user via the user agent. On receipt of the appropriate session cookie and primary authenticators, the IdP/OP may continue to use the (now authenticated) session to interact with the user and determine what credentials and attributes the user wishes the IdP/OP to return to the RP/SP (via a 302 GET or POST response, e.g.) back through the browser, encoded in the appropriate token format. The RP/SP then typically ties that authentication token to the user's browser session via headers or cookies.

A general problem with this flow is that the user must provide their primary authenticators over what may be a compromised user agent or a site masquerading as their IdP/OP. The SSL/TLS session may be secure from eavesdropping but there are many other aspects of the environment that are not guaranteed to be secure, and which militate against trust in the contemplated transaction.

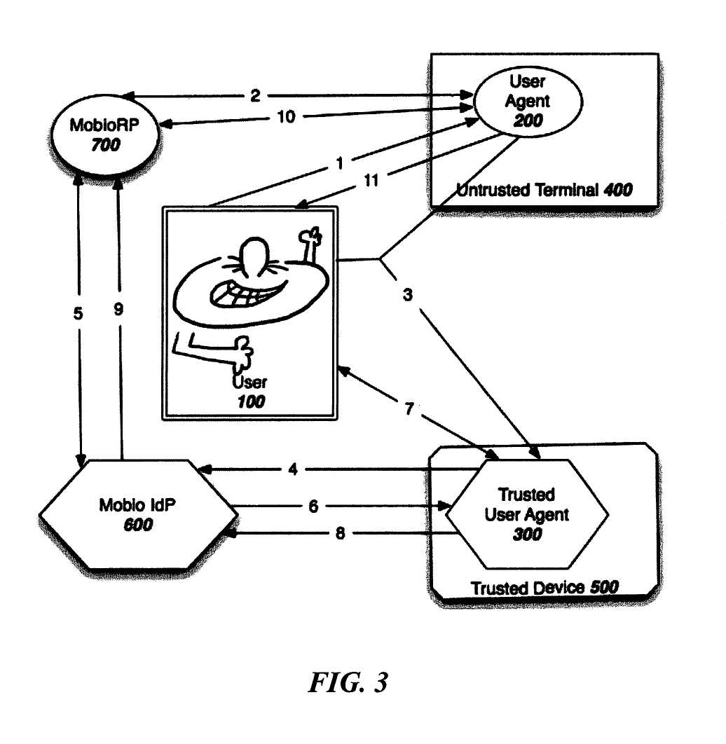

Trusted session transfer addresses these issues by effectively transferring the initial session from the untrusted browser user agent 200 using an existing communications channel, to a trusted user agent 300 on a device 500 under the user's 100 control using a new communications channel (FIG. 3). This is accomplished by making the session cookie with the IdP/OP 600, portable.

One method is to encode the appropriate session information into a graphical representation that can also be placed on the visible web page of the RP/SP 700. (Other options include but are not limited to Sound or tags appropriate for encodings.)

Session information may include a shared secret for the session, as well as the target URI for the session.

A second device such as a smart phone 500 then interprets the session information from the IdP/OP 600. In a preferred embodiment, the user's smart phone 500 obtains the session information by scanning the graphical representation with the phone's built-in camera. The graphical representation can be a 2D barcode, such as a QR code, or any other approach which can represent information in a form readable by the phone's camera.

The information may also be represented in other media, and received via microphone, Bluetooth or other form of communication.

The second device 500 can then use the session information to open a communications channel 2000 with the IdP/OP 600. In a sense, we now have two devices (400 and 500) participating in the same session with the IdP/OP 600.

The trusted user agent 300 can then provide the primary authenticators to the IdP/OP 600 in a way that never passes through the primary (untrusted) browser user agent 200. The trusted agent 300 can use a combination of mutual TLS and/or challenge response and/or OTP to mutually authenticate itself and the user to the IdP/OP 600.

The user 100 can use the trusted and mutually authenticated communications channel to confirm their personal choices.

The IdP/OP 600 may use JavaScript on the page containing the session transfer information to automatically detect that the RP/SP 700 wishes to return the session to the original channel, or the User may manually continue with the session after it has been authenticated in the second channel.

The idea is the moving of, e.g., a session cookie from one device to another, typically encoding—among other things—a shared secret, so that multiple devices can be bound together in the same session.

Other ways to do this would be to display a URL and a base 64 encoded SHA1 hash on the screen of the originating terminal so that the user could type these values into the second (trusted) device. This would look something like:
https://myidp.com/?session=RcEtG6/PY6FM98DAumMXtpnzidY=
   Depending on the application, longer session identifiers can be used.

The preferred embodiment makes use of QR codes and smart phone camera-based scanners as described above to provide a more convenient way to encode and transfer the session.

Definitions:

MobioRP: A relying party (RP) that uses Trusted Session Transfer to authenticate the user.

MobioIdP: An authentication service provider that Trusted Session Transfer uses to validate user identity claims.

RP/SP: Relying Party/Service Provider

IdP/OP: Identity Provider or OpenID Provider.

IdP/OP is embodied by a MobioIdP

RP/SP is embodied by a MobioRP

Information that may be encoded in the Bar code includes, but is not limited to:
Session identifier, for example, base64 encoded SHA256 value Entity ID of the RP Additional RP/SP policy information about the credentials required or supported.

The MobioRP displays the barcode and sets a session cookie. The page with the barcode may contain JavaScript code, for instance, to poll the MobioRP to determine when the session has been upgraded via the back channel.

The user scans the barcode.

The Mobio device sends the information encoded in the barcode to the MobioIdP.

The MobioIdP can perform meta-data discovery on the MobioRP to determine its next steps: this may be, for example, SAML discovery, WS-Fed meta-data exchange, or XRD discovery via host- meta, or a simple lookup from its own configuration databases.

In any case, the identity of the MobioRP is determined and its SSL certificate (we recommend Extended Validation certificates so the Name (what name?) as well as the URL can be displayed to the user . . . ) is confirmed.

This identity is then sent back to the Mobio device for presentation to the user.

The User confirms the identity of the MobioRP to which they are authenticating, and selects the appropriate credential via the Mobio Userinterface. This interface could be used, for instance, to present an appropriate persona and/or set of attributes for selection by the user using the Infocard metaphor.

The selection is then returned from the Mobio to the MobioIdP.

The MobioIdP then selects the proper token format to return via the back channel based on the meta-data discovered earlier.

The token format could be SAML, openID or other future formats.

An example OpenID assertion would be in the format of an unsolicited positive assertion. The session identifier from the Barcode would be passed as an OpenID Attribute exchange parameter.

Similarly, if the MobioRP Policy supported SAML 2.0, then the MobioIdP would sign a SAML bearer token appropriately audience-restricted for the MobioRP. Other proof keys may also be specified per the SAML standard.

With reference to the flow diagram of FIG. 3, here is a summary of the steps described above:
1 User (100) navigates User agent (200) to MobioRP (700)

2 MobioRP (700) establishes session cookie and sends session identifier (barcode) and JavaScript code to user Agent (200)

3 User transfers session from Untrusted Terminal (400) to Trusted Device (500) via camera, etc . . .

4 Trusted User Agent (300) sends information to Mobio IdP (600)

5 Mobio IdP (600) performs meta-data discovery on MobioRP (700)

6 Mobio IdP (600) processes meta-data and sends UI elements to Trusted User Agent (300)

7 Trusted User Agent (300) Presents identity of Mobio RP (700) and allows user to select credentials and attributes that match the policy of the MobioRP (700) discovered in step 5

8 Trusted User Agent (300) provides the selected credentials and attributes to the Mobio IdP (600)

9 The Mobio IdP sends audience restricted token including the session identifier to MobioRP (700)

10 Mobio RP (700) validates the credentials and attributes, and matches them to the original session from step 2, authenticating that session.

11 The polling JavaScript code on the user Agent (200) is then allowed to complete and display the next page to the user (100)

A MobioRP may also act as an IdP for other protocols for backwards compatibility with existing relying parties (RP).

For instance, a large RP (incorporating numerous websites and services, such as a government or other large service provider) may use Passive WS-Fed internally, where the Web page may redirect the User Agent (browser) to a Secure token server. That server would then perform the role of the MobioRP and transform the result into a front channel WS-Fed response that is returned to the RP web page via the normal WS-Fed redirect. This is known in WS-Fed and IMI 1.0 as an RP/STS token transform.

As an example, a user may go to an existing OpenID RP and enter the OP Identifier of their Mobio-based OP (i.e., a MobioRP that supports OpenID as an OpenID provider, or OP).

The RP would have no knowledge of the Mobio authentication. The RP would redirect the user to their OpenID OP.

The OpenID OP would then present the user with a barcode (acting as a MobioRP). The MobioIdP would return an OpenID or SAML token to the MobioRP. The user would be authenticated and the MobioRP would transform the token into the appropriate format for return to the OpenID RP:

It should be noted that the MobioIdP may support any number of protocol gateways in this fashion.

No primary credential information is shared with the proxies who are performing the token transform.

An individual may use the same Mobio to back multiple OpenID accounts from different providers. This allows the user to prevent correlation of their activities.

The MobioRP may be a part of the target web page, it could be part of a Relying Party STS or other token transformation service, or it may be part of a service that performs protocol/token transformations such as an OpenID OP or SAML IdP.

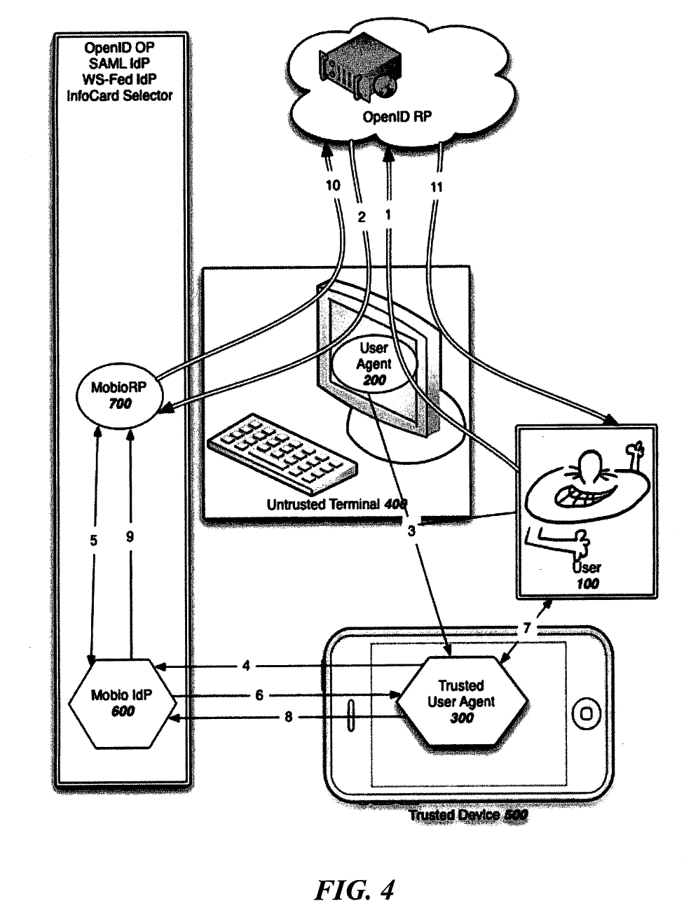

FIG. 4 illustrates the case described above, wherein the Mobio RP is an OpenID provider (OP).

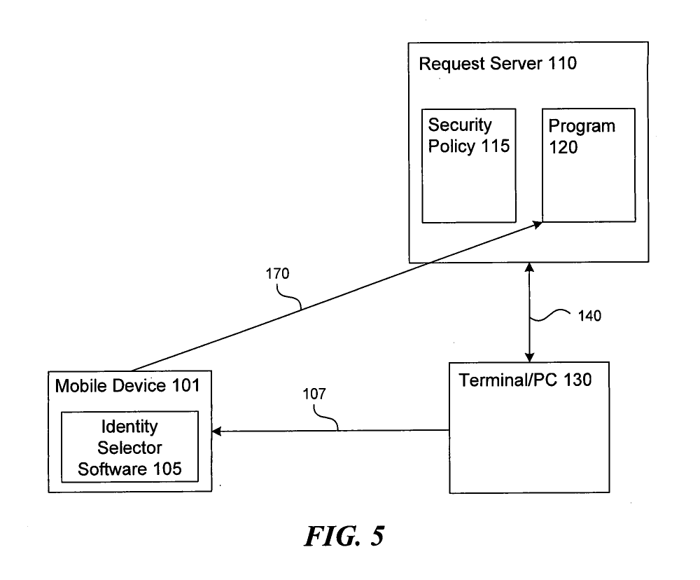

FIG. 5 depicts one version of the enhanced transaction management system of the present invention. There are primarily 5 components

A mobile device 101, such as an iPhone or security card or other personally linked communications device, that has identity selector software 105 on it that can interpret communications (via a communications channel 107) from a server requesting a confirmation or authorization of one or more credentials (“identity selector software”). The mobile device 101 further includes means for receiving the requested credentials via a communications channel 107 that could be any number of communications standards such as Bluetooth, image capture via a camera, e-mail, URL, manual entry or SMS. Other communications standards would also be easy to adapt for use with the present invention.

A terminal/PC/television or other digital device 130 that is in communication with a request server 110. Each request may result in one more or communication sessions 140 that can be uniquely identified by the request server 110, preferably using a session identifier. A session identifier, session ID or session token is a piece of data that is used in network communications (often over HTTP) to identify a session—a series of related message exchanges. Session identifiers become necessary in cases where the communications infrastructure uses a stateless protocol such as HTTP. For example, a buyer who visits a seller's site wants to collect a number of articles in a virtual shopping cart and then finalize the shopping spree by going to the site's checkout page. This typically involves an ongoing communication where several web pages are requested by the client and sent back to them by the server. In such a situation, it is vital to keep track of the current state of the shopper's cart, and a session ID or other one-time password (OTP) is one way to achieve that goal. Another alternative is to use a PC or other server to “simulate” the request by generating a session ID or other identifier to create a link to a request type. In a sense, the digital input device 130 creates a digital string or other session ID that represents a “pre-programmed” request type. For example, the digital device.

As session IDs are often used to identify a user that has logged into a website, they can be used by an attacker to hijack the session and obtain potential privileges. A session ID is often a long randomly-generated string to decrease the probability of obtaining a valid one by means of a brute-force search. Many servers perform additional verification of the client, in case the attacker has obtained the session ID. Locking a session ID to a specific IP address or device identifier is a simple and effective measure as long as the attacker cannot connect to the server using a session ID generated for a specific digital device 130, IP address or some other way of validating a user. The present invention improves upon this system by enabling a mobile device that has been registered with a user to lock a session ID to a given authenticated identity making it extremely difficult to “spoof” the server without possessing both the session ID and the appropriate mobile device. An OTP or similar unique code could also be used to uniquely identify the session.

A request server 110 that includes a security policy 115 (or access to an external server that provides the policy) that dictates what credentials the server needs to effect one or more transactions such as a one time password (“OTP”) or one or more requested credentials.

A program 120 that can generate the initial string of data that provides the address of the request server 110, the session ID (or related identifier) and the requested credentials to the mobile device 101 by sending it to the terminal 130 via the communications session 140 and channel 107 or via a direct communications channel 170 between the program 120 and the mobile device 101. Collectively this string of data is referred to as an “identity request”. The program is also capable of receiving the credentials received in response to the identity request and to link it to the original session 140 and/or request. The program 120 can sit on its own server, at the terminal or the request server. Alternatively, the program 210 could generate a session identifier that “simulates” such a request and transmits the identity request 180 via an email, document or other printed item that can be sent to the user. For example, if the merchant were a payment provider, the program 120 could generate a bill for payment that includes a 2-d barcode that incorporates a session ID that is only valid when initiated by an authenticated mobile device 101. The identity request 180 could be further enhanced to include payment terms and amounts such that the verification and payment step are performed simultaneously. For the purposes of this embodiment, the program 120 is sitting on the request server 110. Once the program 120 receives the appropriate credentials, it communicates with the request server 110, which upgrades the prior communications session 140 (or generates a new, secure communications session 140) with the user to permit the requested transaction. In the preferred embodiment, the validated communications session 140 would include a minimum upgrade of a secured or other private connection that reflects the newly received credential or authorization.

A communications session 140 between the request server and a terminal 130, which are in communications over an Internet or other digital connection, is capable of being identified and upgraded to a secured connection.

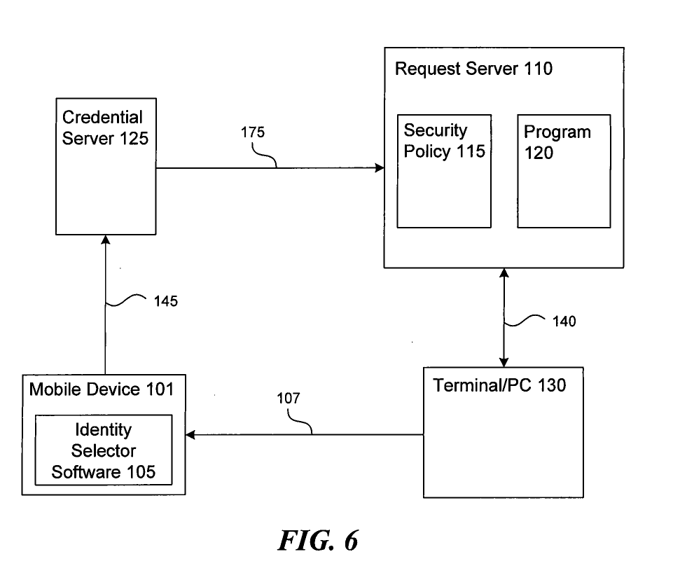

FIG. 6 depicts the system as set forth in FIG. 5 but further includes an optional credential server 125. In this embodiment, the mobile device 101, following its receipt of the identity request from the terminal 130 via communications channel 107 would communicate with the credentials server 125 using the communications channel 145 and approve the use or sharing of one or more credentials that are stored on the credential server 125 and linked to the mobile device 101 for transmission to the request server 110 via communications channel 175. For example, the credential server 125 could store personal information, payment information or other data about the person such as their role (physician) or status within the system (administrator) and would then transmit the credentials approved for sharing buy the mobile device 101 along with the session ID and other information to the request server 110 and program 120.

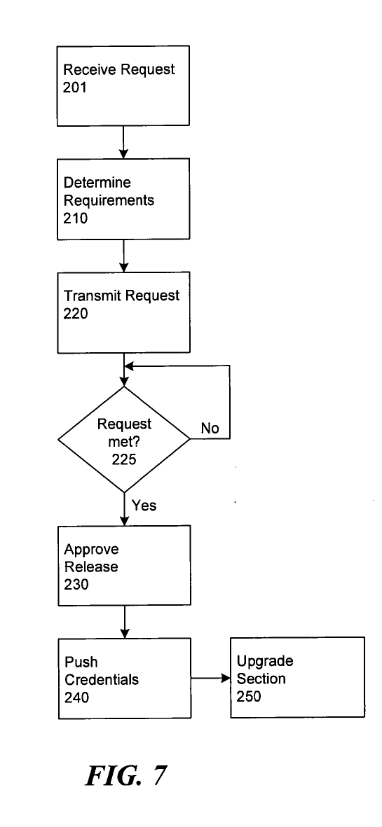

FIG. 7 depicts the flow of a method of the present invention. The method begins in step 201 when a request server 110 receives a request via a communications session 140. The request could be for access to information, a requested transaction, or any number of other requests. In step 210, the server 120 determines what security standards or other credentials or other information is required by accessing a security policy 115. The necessary security policy 115 could be stored on the same server or in a different server.

Once the required information is determined 210, the program 120 or request server 110 would provide the identity request 180 i.e. which credentials are needed and session and/or server ID to a mobile device 101 instep 220. The step 220 of providing the identity request to the mobile device 101 could be accomplished by any number of means including via images (such as barcodes) displayed on the terminal or otherwise printed on paper or some other form, messaging (SMS) directly from the program 120 to the mobile device 101, nearfield (NFC), Bluetooth or any other way of communicating the barcode to a mobile device 100. In the preferred embodiment, the identity request would be transmitted using a barcode that would be displayed on the terminal 130 and read by the identity selector application 105 running on the mobile device 101.

The mobile device 101 would then approve the sharing of the requested credentials in step 230. This could be accomplished directly or indirectly. In the embodiment set forth in FIG. 6, the necessary credentials would be stored in a database on a credentials server 125 that is in communication 145 with the identity selector 105 on the mobile device and contains previously entered information. This database (such as SQL, Oracle, or IIS) would then “push” the credentials and session ID (or some other unique identifier associated with the original request) to a program 120 running on the server 110 via communications channel 175. Alternatively, in the case of the system illustrated in FIG. 5, the mobile device 101 could be running the program 120 and provide the session ID of the session 140 along with server 110 and transmit the appropriate credentials directly back to the request server 110 or program 120 via any of the same communications technologies that were utilized when the server 110 was communicating to the mobile device 101 including, for example, sending an email, SMS, or other web-based request.

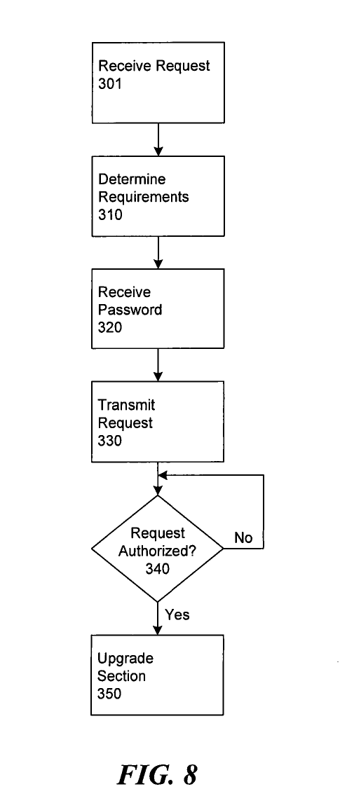

FIG. 8 is a flowchart demonstrating a sample embodiment of the process in the setting of a medical office. Step 301 begins when a request server that permits e-prescriptions receives a request to process a prescription for a patient. In this case, a request to submit the e-prescription is submitted by an office administrator or nurse via a terminal 130. In step 310, the server reaches out to the security policy 115 and determines 315 that the requested information can only be released upon 1) proof that the requesting user has right to access the record; and 2) authenticated approval by a physician.

In the simplest case, the first element (entry of a password) could be accomplished by transmitting a password entry page that enables a user—such as a nurse—to enter 320 her password or the password for the physician. Once the server (or mobile device) receives the password in step 320, the second part—in this case authenticated approval by a physician—would require the physician to authenticate him/herself to the server through a secondary factor or device. As a result, in the present example, the server generates and in step 330 transmits an identity request 180 that indicates the following: the address or location of the requesting server, the kind of credential that will meet these requirements and a session ID for the request. This identity request 180 is transmitted in step 330 to the mobile device 101 via communications channel 107 or communications channel 170. In the preferred embodiment, the identity request 180 is converted into a QR code or other visual or symbolic method for visually transmitting information to a mobile device equipped with a camera for subsequent capture and translation by the identity selector software 105 running on the mobile device 101. Ideally, the identity selector software 105 would make the requested data or information available to the user via a graphical interface—such that the user can see the requested credential list AND approve the release of the identified credentials. As mentioned above, credentials in this example could mean specific personal information, payment details or even payment confirmation information (i.e., validation that the requested payment was indeed processed via an approval or other code).

Once the identity selector software 105 has converted the relevant list of fields using an application on the mobile device 101, the software 105 enables a user to perform the step 340 of authorizing a transaction, which could include the verification of one or more identity credentials. The identity selector software 105 could perform this step by communicating directly via communications channel 170 in the event that it has the credentials on the mobile device 101. Alternatively, as illustrated in FIG. 6, the mobile device 101 could communicate with a credentialing server 125, which holds credentials on behalf of the user and can “push” the information to the request server 110 or program 120 via communications channel 175 based on information contained within the identity request 180. In either event, once the requested credentials have been released and the request authorized in step 340 by the server 110 or program 120, the program 120 or the server performs the step 350 of upgrading or transferring the communication session 140 to reflect user authentication and the request is processed or the user is provided with an opportunity to submit a request (such as a payment approval) via the mobile device 120.

While this embodiment has been described with reference to a single request, as with many web services, there could be multiple requests each requiring a different from of authentication or multiple requests that are processed responsive to a single authenticated session. For example, in the method illustrated with reference to FIG. 8 above, the physician could “authenticate” the medical personnel for general access and use throughout a single day but would be required to authenticate each and every transaction in the case of an e-prescription that requires express physician authorization. Additionally, while this is described as occurring near real-time, these steps could also be performed at differing times using a stage-wise approach.

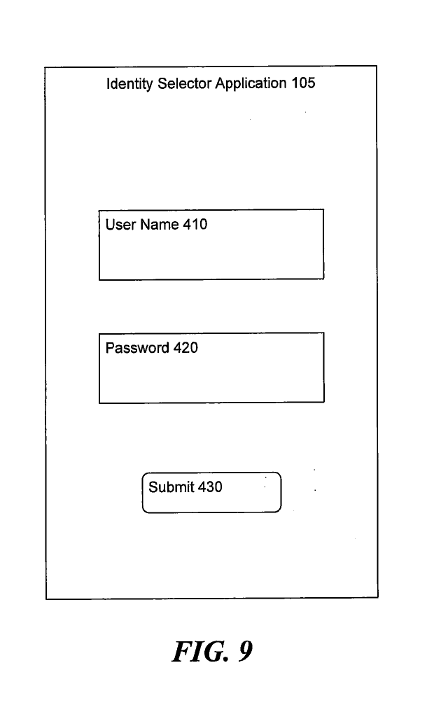

Referring now to FIG. 9, a screen shot illustrating a sample identification selector application prior to utilization is shown. In this instance, the application requires the initial entry of a user name 410 and password 420 before being utilized.

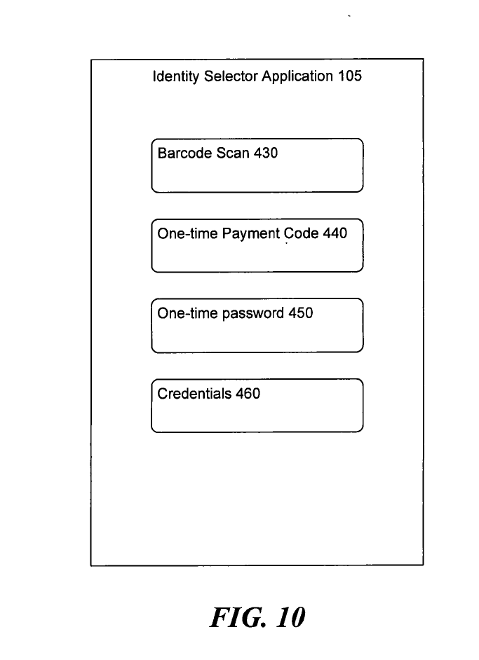

Referring now to FIG. 10, once the user has entered the application, it may utilize one of several different buttons 430, 440, 450, 460. For example, if a code is provided, the user simply selects the barcode scan 410 and a camera is enabled that permits the capture and conversion of the information encoded into the bar code. Additionally, in this embodiment, the identity selector application includes an optional button 440 to permit the generation of a one-time payment code. In this event, the user would generate a single use code that is much like a visa or debit card number and could be effectively used in place of a “fixed” credit card number to permit a single financial transaction. The interface could also optionally provide a button 450 that, when selected, would generate of one or more one-time codes that could be used in place of a corporate network log-in or otherwise used to help “validate” the identity of the party to a requested transaction. In each instance, these one time codes would provide a single instance of user-authentication or approval. Finally, the interface would include standard components such as credentials button 460 that would permit the user to enter, modify or delete any credentials that may be stored on the identity selector application 105.

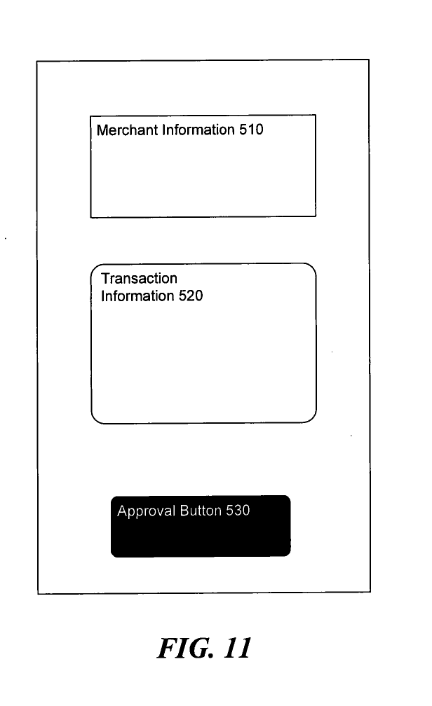

Referring now to FIG. 11, a sample approval screen using the identity selector application is shown. In this instance, the Merchant information 510 would indicate who was being paid (or specify the recipient of the transaction if not payment) along with transaction information 520 that is being requested. This would provide the opportunity for the user to either accept or decline the request. If the request is approved by the user, it would click or accept an approval button 530. This approval is then submitted to either the server is effectively approving a transaction to be conducted via a server 110,125 that communicates with the identity selector application via one or more communications channels 170, 175.

### Propagating Offers

Traditionally, the payment process and associated discounting schemes have connected a single buyer (or customer) and a single seller (or merchant). Merchants have learned over time how to reward “good” customer behavior and have devised numerous techniques to improve the “customer relationship,” and to stimulate repeat business. Modern payment systems and emerging technologies make it possible not only to improve and amplify these techniques, but also to syndicate a buyer's payment experience in the form of discounts or other incentives extended to the buyer's various on-line social networks.

A specialized variant of social commerce (the invention may be interpreted in the context of literature on the subject of “social commerce.” See, for instance: http ://en.wikipedia.org/wiki/Social_commerce: “Social commerce is a subset of electronic commerce that employs collaborative social media tools to assist in online purchasing and selling”), the current invention describes a method to propagate Offers from merchants to individuals who are related to existing customers of that merchant, but who are not yet (necessarily) themselves customers of that merchant.

This Offer Propagation scheme is applicable to any well-defined community of users, hereinafter referred to as a Base Community. Membership in the Base Community is defined by use of a distinguished Identity Token, for payments and other identity-based services, including, in particular, the opt-in receipt of offers from participating Merchants. The invention includes an Attribute Exchange facility for the exchange of identity-related information. In particular, the attribute exchange must provide, after user opt-in, for the discovery of social network information including but not limited to: name and discovery point (e.g., URL and protocol) of social network(s), number of users in social network, etc. The attribute exchange facility also routes the Offers as per the specification provided by the Merchant, consistently with the wishes of the users in the Base Community. For instance, an Offer will propagate from a Merchant only to those Users who:

Have opted-in to receive offers

Fit the description provided by the Merchant, e.g.,
live within 2 miles of the Merchant,
have shopped there before
have spent more then $100 there in the past
are over 18 years of age
are currently within 400 m of the store, etc. (Any combination of these Attributes, as well as many other potential attributes, can form the Merchant's specification of his intended audience. A detailed description of the Attribute Exchange can be found in the relevant filing.)

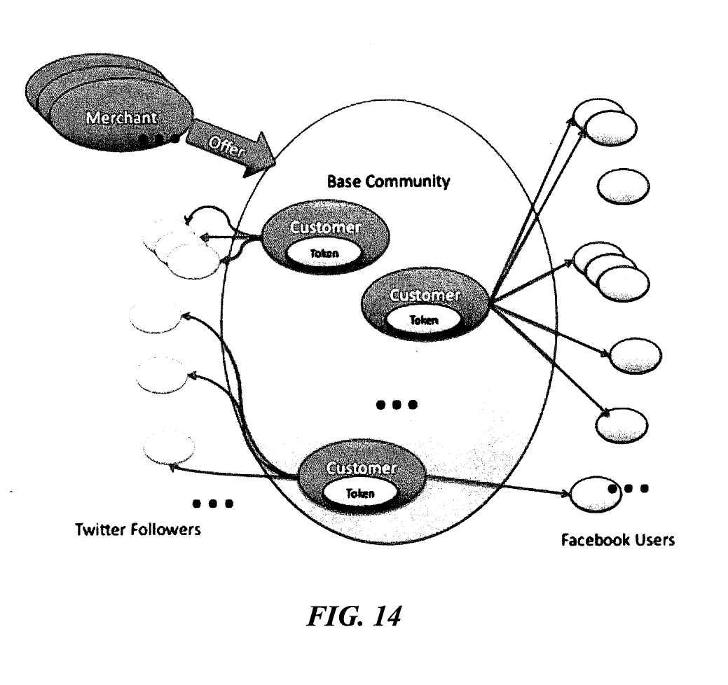

This invention allows the propagation of offers beyond the Base Community, effectively broadening its borders to include entities in the social networks of Base Community members. While these techniques can and should result in the growth of the Base Community itself, this invention focuses on the use of social networks to propagate merchant offers to potential customers outside the existing Base Community of users. See FIG. 14.

An illustrative and general flow is as follows:
Step 1—Offer is extended to a customer
Step 2—If Customer is not already a Base Community member, Customer signs up for Base Community membership
Step 3—If Customer has not previously opted into Social Media propagation functions, Customer can select one or more social networks with which he or she is registered; Customer is thereby opted into Social Media propagation functions
Step 4—The attribute exchange service determines the number and locator of friends in the Customer's social network(s)
Step 5—An appropriate offer is auto-generated and propagated to the Customer's social network(s) in the form of tweets to Twitter, shouts on Facebook, status messages on Skype, and so on . . .

In a preferred embodiment, the propagated offer can be comprised, in whole or in part, of a 2D barcode which, when scanned by the user's token device (typically the Customer's mobile phone), results in the delivery and subsequent acceptance of the Merchant's offer. While the barcode makes it particularly easy to propagate the offer, as well as to track its origin, the invention is not limited to propagation via barcode: the offer could simply be forwarded via email or text message within or without the communications facilities of the respective social networks.

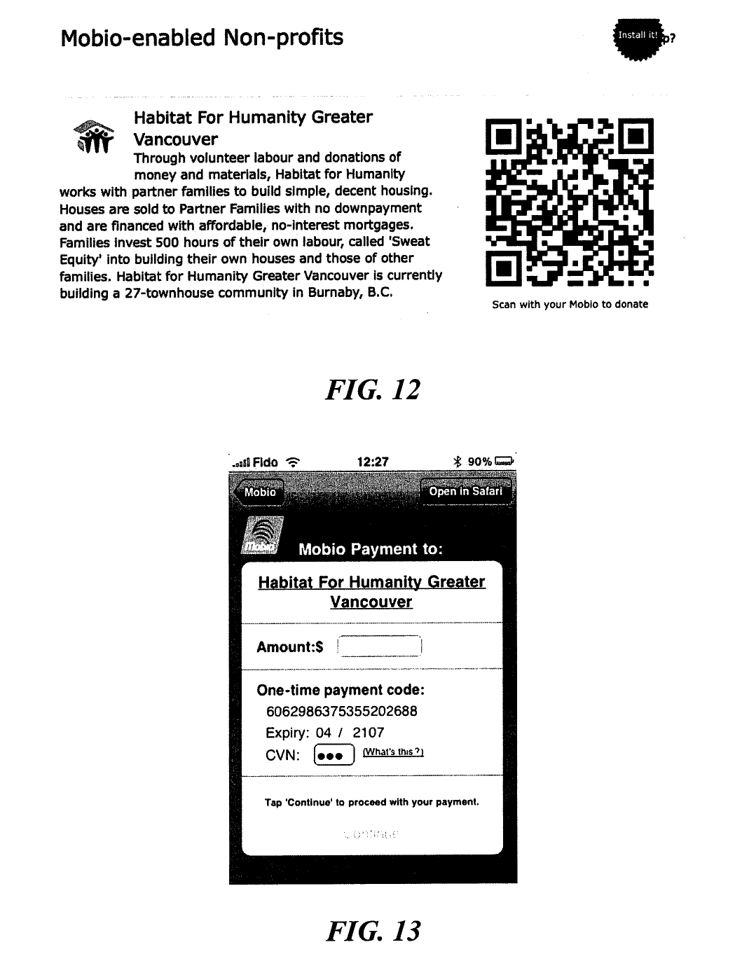

FIG. 12 shows an example of a 2D barcode with associated text. The action of scanning this barcode with the properly equipped user token (in particular, an iPhone running a QR code scanning application provided for this purpose to Base Community members), takes the user (via his cell phone) to a URL where he is presented with the opportunity to make a donation to the specified non-profit entity.

FIG. 13 shows a screen presented to the user upon scanning the code shown in FIG. 12.

Returning to the exemplary implementation of the preferred embodiment, the barcode could be displayed on a Customer's Facebook page, where it could be easily scanned by any of his or her friends, and could be further propagated by these friends with the dual effect of increasing the membership of the Base Community and extending the reach of the original Merchant offer.

A link to a barcode could be included in a Twitter message, thereby allowing followers of the posting Twitter member to scan the barcode, and similar mechanisms are available for other social networks. Successful downstream scans would be recorded to the credit of the originating Base Community member, which could result in “better” offers in future from the same merchant, as well as from other merchants who would recognize the value of this customer's social network (through the consensual sharing of information via the Attribute Exchange).

While the barcode is a component of the offer in the preferred embodiment, it will generally be accompanied by human-readable text describing the offer as well as URLs to the merchant, and the originating customer (e.g., the launching Facebook page or Twitter feed . . . ) along with sign-up instructions for non-members of the Base Community. Note that the mechanism is not restricted to the two levels of the example: propagation is potentially (and preferably) multi-level, with users at each level able to provide barcodes for their social networking contacts, and they in turn for theirs, and so on, to as many levels as desired. The propagation service will track who signed up whom, and distribute reward/credit in appropriate proportion.

The potential network effect of this is striking. An illustrative example follows. The average Facebook user in 2009 has 130 friends, while the average Twitter user has 126 followers. Anecdotal results show that the Word of mouth (WOM) multiplier is about 2.5. (E.g., for each person I tell, 2.5 people will hear my message.)

The Facebook marketing reach for one ‘shout out’ is therefore 130×2.5=325 people, and the equivalent Twitter reach is 126*2.5=315 people. The impact of 100 propagation-enabled transactions a month could be 31500/32500 potential customers with the merchants' marketing messages, all coming from a trusted source—a friend in an existing social network. WOM marketing goes social/digital. The Twitter user population is growing by around 8 million per month . . . .

### Details

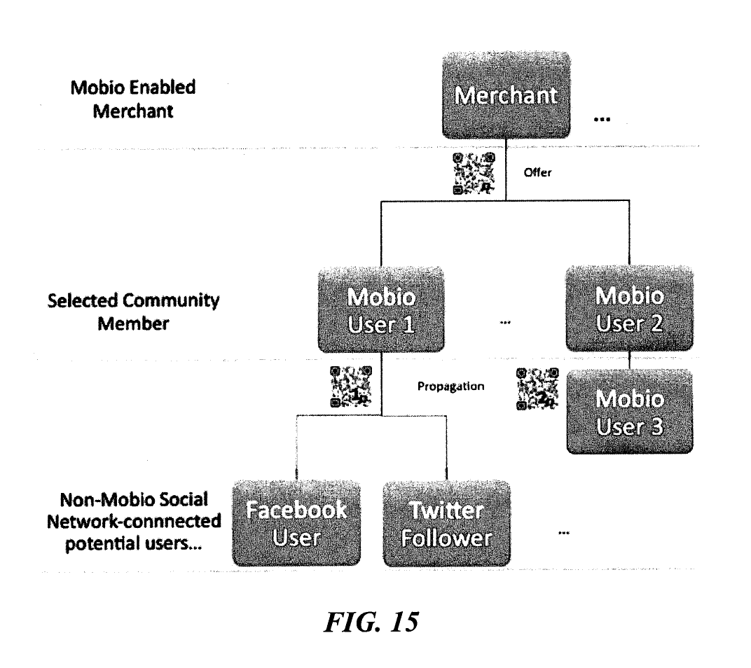

Referring to FIG. 15, a participating merchant specifies an offer in the usual way (i.e, sends it to the Attribute Exchange service with a set of target attributes that define the set of intended recipients: male, over 30, within 300 m of my store, spends over $300 a month on alcohol, etc., for example) with the additional distinguished attribute of propagate set to true, indicating the merchant's desire to propagate the offer to the social networks of the recipients of the offer.

These offers can be acted upon by their recipients in the usual way (i.e., they can go to the store and buy things as per the discount offer, or they can otherwise accept the offer from the merchant). If any of these recipients have opted into the propagation model, then the offer will also be sent to their selected social media interface(s). For instance, if User 1 has opted in with their Facebook feed, a barcode will be generated on his behalf and posted on their Facebook page. This barcode will reflect the original offer, but will also make it possible to track downstream usage. Thus, when members of User 1's social network scan this barcode with the scanning application that they download for this purpose, credit for the scan can be attributed to User 1. Examples of the kind of credit that can be tracked and assigned in this way include but are not limited to:

Indirect benefit: merchant donates a percentage of offer-based transactions to a specified charity; for instance, the first 100 offers taken up at this level of the propagation hierarchy trigger a 2% donation to the United Way, and the first 200 transactions at the next layer of the hierarchy trigger a 1% donation, etc.

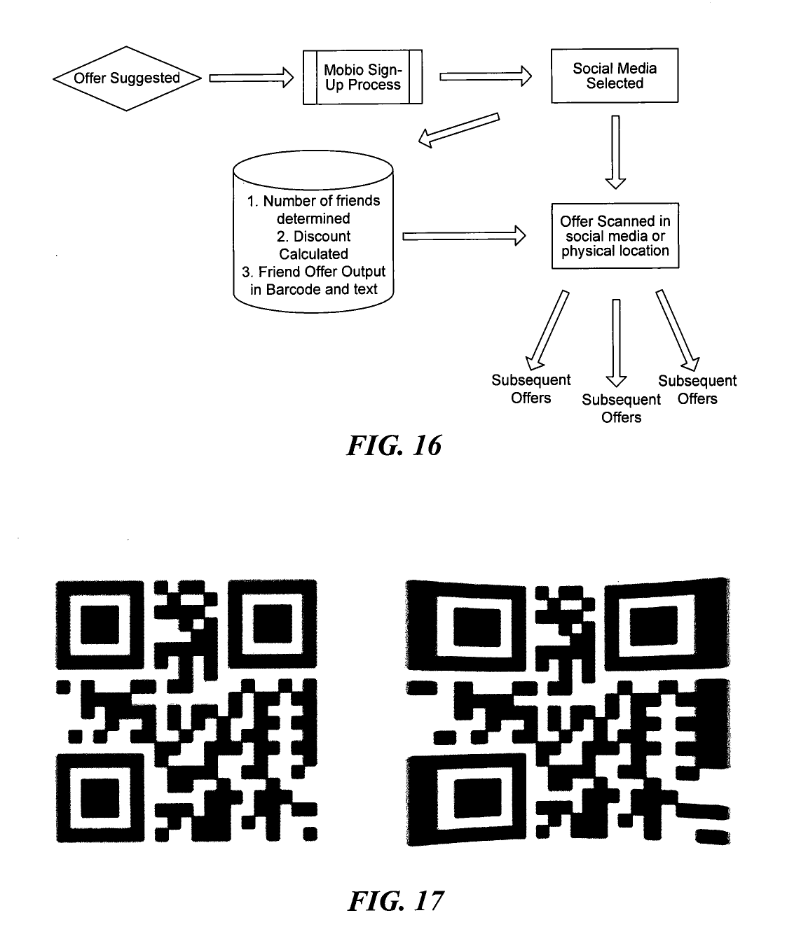

Direct benefit: user benefits directly from offers taken up in his propagation sub-tree; for instance, his discount on his next purchase at the originating merchant will be a percentage that depends on the total amount of offer uptake in his sub-tree at the time of that purchase, etc. See FIG. 16.

In general, there is a limit to the amount of information that can be encoded in a 2D barcode (e.g., 4296 characters in an alphanumeric QR code) (http://en.wikipedia.org/wiki/QR_Code.) This does not limit the generality of the messages comprising the offer described, because the contents of the barcode can be the address of a message, rather than the message itself. The barcode, for example, can be the URL at which an arbitrarily long offer description can be retrieved.

An example of an Offer code can be generated for placement on a Base Community users's Facebook page, where the specific contents of a QR code may contain the following URL: https://mobioidentity.com/pay/exct/8697/user/csinger@mobio.com.

Scanning the code takes the user to the same page shown in FIG. 12 (providing an opportunity to make a donation to the specified charity), and the Offer Propagation service keeps track of the originator (the person whose Facebook page housed the barcode), in this case csinger@mobio.com. Other information in the barcode can include the fact that it is a payment, the identity of the payment processor, and the merchant ID. Any information could be included.

Also, as mentioned earlier, all this information could be replaced by an opaque identifier serving as a pointer to a location (on the internet, e.g., in the form of a URL) where an arbitrary amount and kind of information would be available for authenticated and authorized retrieval.

### 3D Projections of 2D Barcodes

2D Barcodes are in wide and dramatically increasing use worldwide as a means of communicating information to camera-equipped mobile phones. Typically, this usage has been dependent on the availability of a flat and well-lit surface for the display of the code to facilitate scanning by the mobile, hand-held device.

This invention facilitates the scanning of 2D barcodes from arbitrary three-dimensional surfaces. For example, the naïve placement of a 2D barcode on a beer mug or a coffee cup will present a variety of difficulties to a scanning application that is expecting a rendering of the barcode on a flat surface. This invention makes it possible to render the barcode so that when mapped to the 3D surface, it “looks” the same to the camera-based scanning application as if it were on a 2D surface.

Exemplary projections include: 1) projecting a barcode onto a cylindrical object (e.g., a coffee cup or beer mug, a broomstick . . . ); 2) a sphere (a tennis ball, basketball, baseball, etc., or a globe . . . ); 3) any irregular surface (an arbitrary motor component, a chair back, venetian blinds, etc.)

This invention comprises analytic solutions to these specific projection scenarios and others not listed herein. This invention also comprises the use of a ray-casting procedure to achieve the desired effect in the case of arbitrary surfaces, viz., the ability to perceive (from a distinguished vantage point) a 3D barcode as if were a 2D barcode on a plane. The mathematics involved in this ray-casting procedure are similar to those commonly used in 3d computer graphics, specifically, the procedure is similar to that of ray-tracing or beam-tracing systems. (See the attached appendix for procedure details, and “Beam Tracing Polygonal Objects”, Heckert and Hanrahan, Siggraph '84, for a reference on related computer graphics methods.)

FIG. 17 shows an example of a projection onto a cylindrical surface.

Notice how the barcode is “stretched” in proportion to distance from its central axis (more accurately: in proportion to the sine of the angle of deviation from the central axis). When this “stretched” barcode is printed or pasted onto the side of a uniform coffee mug or similar cylindrical object, it appears more or less like the first, unmodified barcode to a viewer situated on the central axis of the barcode.

Other, similar analytic solutions can be developed for any number of specific objects. This invention comprises the use of general ray-casting techniques for the present purposes.

The result of the ray-casting procedure may be defined relative to a 2D parameterization of the surface points of the model. Thus, the results of the procedure may be displayed using standard texture mapping techniques—where the result of mapping the texture (the distorted 2D barcode) is that the mapped surface (the coffee cup, for example) will appear to a 2D barcode scanner as would a planar barcode.

An alternate way of accomplishing all of these objectives without appeal to digital techniques is to invoke well-understood, traditional, photographic techniques. Specifically: 1) the arbitrary 3D surface is coated with a photographic film; 2) the 2D barcode is projected onto this film, thereby exposing the film with the image of the barcode; 3) the film is removed from the surface and developed. This developed film now shows the desired image, which can be copied and pasted onto identical 3D objects. This application lays claim to both this analogue process as well as to the digital process described herein. Further details are provided in Appendix A.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

### Appendix A

### 1 Procedure for the General Case

Given a section of a 3D surface, parameterized by the function p: [symbol] ²→ [symbol] ³, and a view point w∈ [symbol] ³, the color at the surface point p(u, v) can be determined as follows:

First, define a plane in 3D, perpendicular to the gaze direction of the viewer, using an equation of the form h·x=d, with h, x∈ [symbol] ³, d∈R. Select a rectangular region of that plane which will correspond to the barcode data. Conceptually, we may think of this plane as an artificial flat surface, which we insert into the world at some point between the view point and the 3D object. We will trace lines between the view point and the object, calculate the point of intersection between these lines and the plane, and use that information to determine the color of the object. In this manner, it is possible to select colors for all surface points p(u, v) such that a camera positioned at view point v will perceive the barcode image as if it were displayed on the at surface of the plane.

We may parameterize the line L(t) between the view point and the surface point using the equation:

L(t):=(p(u,v)−w)t+w.

The point of intersection with the plane h·x=d will thus occur at,

$$t = \frac{d - h \cdot w}{h \cdot p ( u , v ) - h \cdot w} .$$

Therefore, the point of intersection between the plane and the line L(t) will be,

$$( p ( u , v ) - w ) \frac{d - h \cdot w}{h \cdot p ( u , v ) - h \cdot w} + w .$$

Sampling the barcode color defined for this point in the plane will yield the necessary color for the surface at point p(u, v).

1.-6. (canceled)

7. A system comprising:
a. a digital device for generating a request;
b. a request server configured to receive the request via at least one communications session and to generate an identity request in response to the received request;
c. in communications with the server, an identity selector application for running on a mobile device, wherein the mobile device has been linked to one or more credentials and is configured to receive the identity request;
d. a database, in communication with the request server and the identity selector application, that is capable of storing the one or more credentials for use by the request server; and,
e. a program or routine, running on the request server, for receiving the one or more credentials stored in the database in response to the identity request, and associating the received one or more credentials with the communication session.

8. The system of claim 7, wherein the digital device includes a computer with a processing unit, an input device for enabling a user to generate a request, and a printer for printing a barcode for encoding request data.

9. The system of claim 7, wherein communications between the request server and the identify selector is performed using bar codes imaged by the mobile device.

10. The system of claim 7, wherein communications between the request server and the identify selector is performed using Bluetooth or nearfield (NFC) communications with the mobile device.

11. The system of claim 7, wherein communications between the request server and the identify selector is performed using short message service (SMS) communications with the mobile device.

12. The system of claim 7, wherein the database stores personal credentials for a user of the mobile device, including a name and address for the user.

13. The system of claim 7, wherein the database stores status credentials, including credentials that provide an indication of a user's status or privileges for one or more systems.

14. The system of claim 7, wherein the mobile device is a mobile phone.

15. A method for establishing a secured session between a mobile digital device and a server, the method comprising:
a. initiating at least part of a communication session between a terminal and the server, wherein the communication session includes an identification code for the communication session;
b. receiving one or more requests via the communication session from the terminal;
c. determining the credentials that are required to permit requests;
d. transmitting a list of required credentials to the terminal along with the identification code for the session;
e. receiving the credentials and the identification code for the session from a credential server; and,
f. applying one or more security protocols to improve security of future communications session between the terminal and the server.

16. The method of claim 15, wherein the credential server is a mobile digital device, wherein the mobile digital device is a smartphone, and wherein the terminal is a personal computer.

17. The method of claim 15, wherein determining the credentials includes determining first and second different credentials that are required for first and second different requests, respectively.

18. The method of claim 15, wherein transmitting a list of required credentials further includes converting requested credentials and identification code into a QR barcode for transmission to the terminal.

19. The method of claim 15, wherein requested credentials are embodied in a previously generated QR barcode that is retrieved and transmitted to the terminal.

20. A method for enabling simple approval of one or more requests submitted to a server, the method comprising:
a. retrieving a list of one or more credentials required to process a transaction request along with an identification code for the server performing the transaction;
b. responsive to approval from the user, accessing one or more user credentials and personal information stored on the credential server,
wherein the one or more user credentials and personal information is associated with the user and was previously submitted to the credential server by the user, and,
wherein identity selector software on a mobile device for the user is associated with the one or more user credentials; and,
c. transmitting the one or more credentials to the server based in part on the identification code and the approval from the user.

21. The method of claim 20, further comprising linking the identity software with the one or more user credentials on the credential server, including submitting a one time code linked to the one or more user credentials.

22. The method of claim 20, wherein the one or more user credentials includes personal information or payment information.

23. The method of claim 20, wherein the retrieving a list of one or more credentials required to process a transaction further includes retrieving criteria being applied to credentials by the credential server.

24. The method of claim 23, wherein transmitting one or more credentials to the server includes transmitting an indicator of whether criteria being applied to the credentials by the server performing the transaction have been met.

25. The method of claim 24, wherein the criteria being applied is whether a party requesting the transaction is at least 21 years of age.

26. The method of claim 24, wherein the criteria being applied is whether a requested payment has been performed.

27. A system comprising:
a request server that is capable of receiving a request from a terminal via one or more communications sessions and generating a list of one or more credentials that are required to perform the received request;
a credential server, in communication with the request server and an identity selector application, wherein the credential server is configured for storing one or more credentials that are needed by the request server; wherein the identity selector application runs on a mobile device that has been linked to one or more credentials; and
a program or routine, running on the request server, for receiving credentials from the credential server and linking the received credentials to the one or more communication sessions between the terminal and the request server.

28. The system of claim 27 wherein the terminal is a computer, mobile device, or TV, and the mobile device is a mobile phone.

29. The system of claim 27 wherein communications between the request server and the identity selector is performed by reading barcodes, or using nearfield (NFC), Bluetooth, or SMS communications.

30. The system of claim 27 wherein the credential server includes personal credentials or status credentials, and wherein the credentials comply with OpenID or Security Assertion Markup Language (SAML).

31. A method for establishing a secured session between a terminal and a server comprising:
establishing a communication session between a terminal and a server that includes an identification code for the session;
receiving one or more request(s) via the communication session from the terminal;
determining credentials required to permit the request; and, transmitting a list of required credentials to the terminal along with the identification code for the session.

32. A method for enabling simple approval of one or more requests submitted to a server via a network, the method comprising:
receiving a request to process a financial transaction,
wherein the request is received from a mobile phone,
wherein the mobile phone provided the request wirelessly to the network,
wherein the request includes an identification code for the server, and
wherein the request was automatically generated by the mobile phone by imaging a barcode or received via nearfield, Bluetooth, or SMS communications with the mobile phone;
receiving a user approval signal from the mobile phone;
accessing stored user credentials or personal information;
wherein the user credentials or personal information was previously associated with the user;
wherein identity selector software on a mobile device for the user is associated with the one or more user credentials; and,
transmitting the user credentials or personal information based in part on the identification code and the approval from the user.

33. The method of claim 32, wherein the identification code is derived from a URL encoded in a two-dimensional barcode, wherein the mobile device provides data encoded in the URL to a wireless telephone network, wherein the wireless telephone network provides the data to the network, wherein the network is the internet, and wherein the user credentials and personal information are stored on a credential server that communicates with the server and provides approval to the server for fulfillment of the financial transaction.

34. The method of claim 23, wherein transmitting the user credentials or personal information includes transmitting an indicator of whether criteria being applied to the credentials have been met, wherein the criteria include a user age or user financial status.

35. A method for enabling approval of at least one request submitted to a server via a user's mobile device, the method comprising:
receiving, at the mobile device, a request to process a financial transaction,
wherein the request includes an identification code for the server, and
wherein the request is automatically generated by the mobile device by imaging a barcode or receiving data via nearfield, Bluetooth, or SMS communications;
displaying or providing a request to the user via the mobile device a request for the user to authorize the transaction;
wirelessly providing the request via the mobile device if approval is received based on the displayed or provided request;
wherein the server receives user credentials based in part on the identification code and the approval from the user, and
wherein the credentials were previously stored in the network.
